(19) United States
(12) Patent Application Publication
(10) Pub. No.: US 2019/0076922 A1
(43) Pub. Date: Mar. 14, 2019

(54) APPARATUS AND METHOD FOR CONTROLLING A SINTERING PROCESS

(71) Applicant: LINDE AKTIENGESELLSCHAFT, München (DE)

(72) Inventor: Akin Malas, Gillette, NJ (US)

(21) Appl. No.: 15/636,695

(22) PCT Filed: Jan. 7, 2016
(86) PCT No.: PCT/EP2016/000015

§ 371 Date: Jun. 29, 2017

(30) Foreign Application Priority Data
Jan. 8, 2015 (EP) 15000023.0

(51) Int. Cl. B22F 3/10; B22F 3/00; F27D 19/00; F27B 9/40

(52) U.S. Cl. CPC B22F 3/101; B22F 3/003; F27D 2019/0068; F27B 9/40; F27D 2019/0012; F27D 19/00

(57) ABSTRACT

An apparatus (150) for controlling a sintering process in a sintering furnace (100), includes a preheating zone (120) and a high heat zone (130), further comprising at least two measuring devices (151, 152, 153, 154), wherein the at least two measuring devices comprise at least one measuring device in the preheating zone (120) and at least one measuring device in the high heat zone (130) for analyzing a furnace atmosphere at the respective zone, and adjusting means (155, 156) for adjusting a composition of the furnace atmosphere based on measurement values acquired by the at least two measuring devices (151, 152, 153, 154) in the respective zones (110, 120, 130, 140).

The present invention relates to an apparatus and a method for controlling a sintering process and to a sintering furnace including such an apparatus.

### PRIOR ART

Metal injection molding is a process for forming parts from metal powder mixed with binder material. The mixture of metal powder and binder material is pressed into forms. Afterwards, the binder material is removed using, for example, a solvent, a thermal treatment, a catalytic process, or a combination thereof.

The result of this process is a metal part that has to be further densified by using a furnace process called sintering. In that furnace process, a furnace atmosphere is used to control the reactions taking place on the surface of the metal part. Reactions within the furnace atmosphere may be controlled by changing the compositions of the furnace atmosphere.

The metal injection molding (MIM) sintering process has a complex chemistry which requires extensive measurement and precise control. Control of carbon content in a metal injection molding component is an extremely sensitive process due to the high heat and the complex geometry of the parts. Atmosphere control of heat treatment furnaces may be made by means of analyzers.

Existing systems for controlling the heat treatment atmosphere for components to be sintered only rely on input gases going into the furnace and on the results of the components which are already sintered. Depending on the results, parts may be treated as suitable for further use or as scrap. Altering conditions would only affect the quality of the parts in corresponding specific zones of the furnace. Parts having passed these zones would be omitted and the results for these parts would not be changed.

Thus, the problem to be solved is to provide a possibility for controlling a sintering process in order to achieve sintered components of high quality over a longer period of time, particularly components with a constant carbon content.

### DISCLOSURE OF THE INVENTION

The problem is solved by an apparatus for controlling a sintering process, a sintering furnace including such an apparatus, and a method for controlling a sintering process according to the independent claims. Advantageous embodiments are the subject of the dependent claims as well as of the following description.

### ADVANTAGES OF THE INVENTION

An apparatus according to the invention serves for controlling a sintering process in a sintering furnace comprising a pre-heating zone and a high heat zone . The apparatus comprises at least two measuring devices, wherein the at least two measuring devices comprise at least one measuring device in the pre-heating zone and at least one measuring device in the high heat zone. The measuring devices are used for analyzing a furnace atmosphere at the respective zone. The apparatus further comprises adjusting means for adjusting a composition of the furnace atmosphere based on measurement values acquired by the at least two measuring devices in the respective zones.

Using measuring devices in different zones of the sintering apparatus improves adjusting the composition of the furnace atmosphere over only relying on input gas composition and judging the result at the very end of the process. The apparatus according to the invention allows for analyzing the composition in the pre-heating zone and in the high temperature zone of the sintering furnace. The composition of the furnace atmosphere is adjusted depending on the values measured by both of the two measuring devices. Also, choosing different compositions depending on different zones makes it possible to achieve a constant carbon potential in the furnace atmosphere and thus a constant carbon content in sintered parts, e.g. in metal injection molding parts.

Preferably, the at least two measuring devices are chosen from oxygen analyzers, dew point analyzers, lambda probes and hydrogen analyzers. These measuring devices allow for analyzing the composition of the furnace atmosphere with usually used gases.

It is of advantage if the at least two measuring devices are chosen from an oxygen analyzer in the high heat zone and a dew point analyzer in the pre-heating zone. These measuring devices placed in the mentioned zones of the sintering furnace yield the best analyzing results.

Preferably, the adjusting means are adapted to adjust the composition of the furnace atmosphere by altering humidity and/or at least one of the concentrations of hydrogen, nitrogen and propane. These gases are typically used for the furnace atmosphere in a sintering furnace. Thus, adjusting the composition by altering at least one of these gases in dependence of the analysis of the furnace atmosphere leads to improved sintering results. Adjusting all of these gases, however, is also preferred and leads to even better results.

The furnace atmosphere in the pre-heating zone is controlled depending on the measured value achieved by the measuring device located in the pre-heating zone and depending on the measured value achieved by the measuring device located in the high heat zone. Depending on both measured values the atmosphere in the pre-heating zone is changed, for example by introducing one or more gas flows and thereby altering the gas composition in the pre-heating zone.

The same applies to the furnace atmosphere in the high heat zone: It is controlled depending on the measured value achieved by the measuring device located in the pre-heating zone and depending on the measured value achieved by the measuring device located in the high heat zone.

According to the invention the atmosphere in the pre-heating zone and the atmosphere in the high heat zone are analyzed, that is at least one value characterizing the pre-heating atmosphere and at least one value characterizing the high heat atmosphere are measured. The analysis of both measured values is used control the atmosphere in the pre-heating zone and in the high heat zone. Thus, the adjustment of the atmosphere in the pre-heating zone depends on both measured values and the adjustment of the atmosphere in the high heat zone also depends on both measured values.

Preferably, the measured values acquired by both measuring devices are compared with pre-determined or pre-set values and depending on the difference between the nominal and the actual values the atmosphere in the pre-heating zone and the atmosphere in the high heat zone are altered.

Advantageously, the adjusting means are adapted to adjust the composition of the furnace atmosphere based on a carbon potential and/or an oxygen concentration and/or a hydrogen ratio curve. The experimental hydrogen curve tends to show a downward curve meaning that the hydrogen acts as an agent which is non reacting with carbon in the metal injection molding (MIM) powder mixture up to a value at approximately 30% and after that it starts to act oppositely as a decarburizing agent. The curve tends to be dependent on many factors and has not been understood nor recognized by the theory in the industry as a proven phenomenon. As the carbon potential is an essential quantity for achieving a constant carbon content, a function correlating the carbon potential and the oxygen concentration and/or a hydrogen ratio curve of the furnace atmosphere can be used to improve the carbon content of sintered parts. Carbon potential or in other words the activity of carbon is a function of temperature, contents of CO2, CO, H2 gases in the atmosphere mixture and is directly related to the alloying elements in the MIM powder mixture.]

A sintering furnace according to the invention includes an apparatus according to the invention. Preferably, the sintering furnace is a sintering furnace for sintering metal injection molding parts, since metal injection molding is very sensitive to a control of the carbon content due to high temperatures and the complex geometry of the parts. Alternatively, the sintering furnace comprises a sintering furnace for powder metal sintering, since powder metal sintering uses a similar process.

A method according to the invention serves for controlling a sintering process in a sintering furnace. A furnace atmosphere is analyzed by at least two measuring devices, wherein the at least two measuring devices comprise at least one measuring device in each of at least two different zones of the sintering furnace, and a composition of the furnace atmosphere is adjusted based on measurement values acquired by the at least two measuring devices in the respective zones.

Preferably, analyzing the furnace atmosphere includes at least one of measuring an oxygen concentration, a hydrogen concentration, a dew point temperature and a lambda ratio. The lambda ratio or lambda value is similar to the oxygen concentration but is defined as a function of electrical activity of oxygen atoms through the lattice structure of a zirconia ceramic at temperatures above 650 C.

Advantageously, the different zones are chosen from an entry zone, a pre-heating zone, a high heat zone and a cooling zone.

It is of advantage if adjusting the composition of the furnace atmosphere includes altering humidity and/or at least one of the concentrations of hydrogen, nitrogen and propane.

Preferably, the composition of the furnace atmosphere is adjusted based on a carbon potential and an oxygen concentration and/or a hydrogen ratio curve.

Advantageously, the method is used for a sintering process of sintering metal injection molding parts or of sintering powder metal.

Embodiments and advantages of a method according to the present invention correspond to the embodiments and advantages of an apparatus according to the invention mentioned above.

### DESCRIPTION OF THE DRAWING

FIG. 1 shows a sintering apparatus with an apparatus for controlling a sintering process according to the invention in a preferred embodiment.

### EMBODIMENT OF THE INVENTION

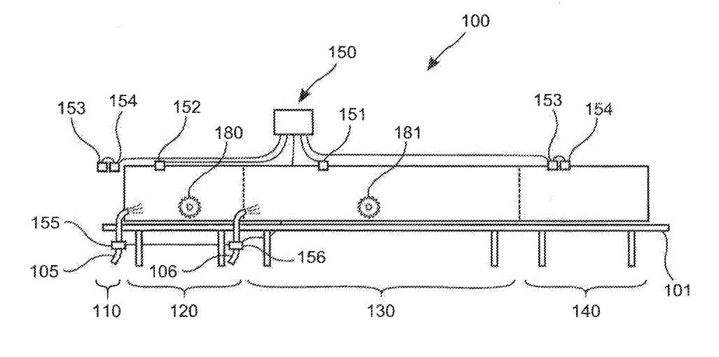

In FIG. 1, a schematical drawing of a sintering furnace 100, for example for sintering metal injection molding parts, is shown. Parts 180, 181 are placed on a bench 101 after metal injection molding and transported, e.g. by a conveyor, from the left end of the bench 101 to the right end of the bench 101.

Parts 180, 181, which are exemplarily shown in the sintering furnace 100, thus pass through different zones of the sintering furnace 100. These zones comprise an entry zone 110 at the beginning, followed by a pre-heating zone 120, a subsequent high heat zone 130 and a cooling zone 140 at the end.

An apparatus 150 for controlling the sintering process in the sintering furnace 100 is placed, for example, near the bench of the sintering furnace 100. The apparatus 150 comprises, for example, six measuring devices. These measuring devices are an oxygen analyzer 151 in the high heat zone 130, a dew point analyzer 152 in the pre-heating zone 120, a lambda probe 153 in the cooling zone 140, a hydrogen analyzer 154 in the cooling zone 140, a lambda probe 153 in the entry zone 110 and a hydrogen analyzer 154 in the entry zone 110.

The apparatus 150 is adapted to receive values measured by these six measuring devices and is further adapted to control adjusting means 155, 156. The adjusting means 155, 156 are placed at inlets 105, 106, which inlets are used for supply a gas mixture to the zones of the sintering furnace 100. This gas mixture is used as a furnace atmosphere for the sintering process or to alter an existing furnace atmosphere.

By controlling the adjusting means, the composition of the gas mixture in the sintering furnace, i.e. the furnace atmosphere, may be altered based on values measured by the measuring means 151, 152, 153 and 154.

In particular, the amount and relative composition of a hydrogen, humidty, nitrogen and propane mixture may be adjusted based on a formula of carbon potential versus values measured by the oxygen analyzer and a hydrogen ratio curve which determines the activation of the metal injection molding (MIM) lubricants to desolve in a debinding stage in the pre-heating zone 120 (also called debinding zone) of the furnace. The debinding of the plastic binding material is reacting with hydrogen and the water vapour (H2O), therefore the amount of humidity is calculated based on a basic stoichiometric calculation of the amount of water needed to burn of the plastic at an elevated temperature up to 800 C. The composition of the humidy or free oxygen is calculated by the weight of powder mix (so-called brown component) going in as a furnace charge. Then the amount of plastic present and then the amount of humidity to burn this off from the brown part is calculated. The flow rates of the debinding zone are then changed by changing the nitrogen or hydrogen carrier gas passing through a gas humidifier hence providing the necessary water content.

In the meantime the humidity content in the pre-heating (debinding) zone is continuously measured to keep the values constant hence making sure the environment has enough humidty to burn off (react with) the plastic input to the furnace. This will remove all plastic binders allowing the base powder mix to enter the high heat (sintering) zone with the right carbon content. The apparatus then will maintain the base level carbon content by creating a carbon neutral atmosphere.

1-12. (canceled)

13. An apparatus (150) for controlling a sintering process in a sintering furnace (100), comprising:
a pre-heating zone (120) and a high heat zone (130);
at least two measuring devices (151, 152, 153, 154), the at least two measuring devices comprising at least one measuring device in the pre-heating zone (120) and at least one measuring device in the high heat zone (130) for analyzing a furnace atmosphere at a respective one of the zones; and
adjusting means (155, 156) for adjusting a composition of the furnace atmosphere based on measurement values acquired by the at least two measuring devices (151, 152, 153, 154) in the respective zones (110, 120, 130, 140).

14. The apparatus (150) according to claim 13, wherein the at least two measuring devices (151, 152, 153, 154) comprise devices selected from the group consisting of oxygen analyzers (151), dew point analyzers (152), lambda probes (153), and hydrogen analyzers (154).

15. The apparatus according to claim 13, wherein the at least two measuring devices (151, 152, 153, 154) are devices selected from the group consisting of an oxygen analyzer (151) in the high heat zone (130), and a dew point analyzer (152) in the pre-heating zone (120).

16. The apparatus (150) according to claim 13, wherein the adjusting means (155, 156) are adapted to adjust the composition of the furnace atmosphere by altering humidity in the furnace atmosphere.

17. The apparatus (150) according to claim 13, wherein the adjusting means (155, 156) are adapted to adjust the composition of the furnace atmosphere by altering at least one of concentrations of hydrogen, nitrogen and propane in the furnace atmosphere.

18. The apparatus (150) according to claim 13, wherein the adjusting means (155, 156) are adapted to adjust the composition of the furnace atmosphere by altering humidity and at least one of concentrations of hydrogen, nitrogen and propane in the furnace atmosphere.

19. The apparatus (150) according to claim 13, wherein the adjusting means (155, 156) are adapted to adjust the composition of the furnace atmosphere based on a carbon potential and an oxygen concentration in the furnace atmosphere.

20. The apparatus (150) according to claim 13, wherein the adjusting means (155, 156) are adapted to adjust the composition of the furnace atmosphere based on a carbon potential, and a hydrogen ratio curve in the furnace atmosphere.

21. The apparatus (150) according to claim 13, wherein the adjusting means (155, 156) are adapted to adjust the composition of the furnace atmosphere based on a carbon potential, an oxygen concentration and a hydrogen ratio curve in the furnace atmosphere.

22. A sintering furnace (100), comprising an apparatus (150) for controlling a sintering process in a sintering furnace (100), the apparatus comprising:
a pre-heating zone (120) and a high heat zone (130);
at least two measuring devices (151, 152, 153, 154), the at least two measuring devices comprising at least one measuring device in the pre-heating zone (120) and at least one measuring device in the high heat zone (130) for analyzing a furnace atmosphere at a respective one of the zones; and
adjusting means (155, 156) for adjusting a composition of the furnace atmosphere based on measurement values acquired by the at least two measuring devices (151, 152, 153, 154) in the respective zones (110, 120, 130, 140).

23. The sintering furnace (100) according to claim 22, wherein the sintering furnace (100) is a furnace selected from the group consisting of a sintering furnace for sintering metal injection molding parts, and a sintering furnace for powder metal sintering.

24. A method for controlling a sintering process in a sintering furnace (100), comprising:
analyzing a pre-heating zone (120) and a high heat zone (130) of a furnace atmosphere by at least two measuring devices (151, 152, 153, 154), the at least two measuring devices comprising at least one measuring device in the pre-heating zone (120) and at least one measuring device in the high heat zone (130); and
adjusting a composition of the furnace atmosphere based on measurement values acquired by the at least two measuring devices (151, 152, 153, 154) in the respective zones (110, 120, 130, 140).

25. The method according to claim 24, wherein the analyzing the furnace atmosphere comprises at least one of measuring an oxygen concentration, measuring a hydrogen concentration, measuring a dew point temperature, and measuring a lambda ratio.

26. The method according to claim 24, wherein the adjusting the composition of the furnace atmosphere comprises altering a humidity in the furnace atmosphere.

27. The method according to claim 24, wherein the adjusting the composition of the furnace atmosphere comprises altering at least one of concentrations of hydrogen, nitrogen and propane in the furnace atmosphere.

28. The method according to claim 24, wherein the adjusting the composition of the furnace atmosphere comprises altering a humidity and at least one of concentrations of hydrogen, nitrogen and propane in the furnace atmosphere.

29. The method according to claim 24, wherein the adjusting the composition of the furnace atmosphere is based on a carbon potential and an oxygen concentration in the furnace atmosphere.

30. The method according to claim 24, wherein the adjusting the composition of the furnace atmosphere is based on a carbon potential and a hydrogen ratio curve in the furnace atmosphere.

31. The method according to claim 24, wherein the adjusting the composition of the furnace atmosphere is based on a carbon potential, an oxygen concentration, and a hydrogen ratio curve in the furnace atmosphere.

32. The method according to claim 24, further comprising using the method for a process selected from the group consisting of sintering metal injection molding parts, and sintering powder metals.
